(19) United States
(12) Patent Application Publication
(10) Pub. No.: US 2002/0064283 A1
(43) Pub. Date: May 30, 2002

(54) Method and system for object encryption using transparent key management

(75) Inventor: Thomas J. Parenty, Oakland, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Parenty Consulting, LLC, Oakland, CA

(21) Appl. No.: 09/996,283

(22) Filed: Nov. 27, 2001

Related U.S. Application Data
(60) Provisional application No. 60/255,222, filed on Dec. 12, 2000.
(60) Provisional application No. 60/253,017, filed on Nov. 27, 2000.

(51) Int. Cl. H04L 9/00

(52) U.S. Cl. 380/277

(57) ABSTRACT

A method and system are provided for encrypting objects that imposes limited or no key management responsibilities on end users or administrators, that works easily across organizational boundaries, and does not require the explicit installation of client software.

### CROSS-REFERENCES TO RELATED APPLICATIONS

This application is a nonprovisional of U.S. Application No. 60/255,222 filed Dec. 12, 2000, and a nonprovisional of U.S. Application No. 60/253,017 filed Nov. 27, 2001, both of which are incorporated by reference in their entirety for all purposes.

### BACKGROUND OF THE INVENTION

The present invention relates generally to object encryption. More particularly, the present invention relates to the use of transparent key management for encrypting objects. These resulting cipher text objects may be subsequently stored locally or transmitted.

A problem of encrypting objects is secure distribution of encryption keys. A number of different approaches have been employed to distribute keys. Keys may be distributed manually via electronic media, e.g., floppy disk or smart card, or non-electronic media, e.g., Mylar™ tape. Keys may also be distributed via centralized key distribution centers, e.g., Kerberos, or Public Key Infrastructures (PKI). Most of these approaches have disadvantages. The manual distribution of keys often does not scale well. Centralized key distribution centers and PKI infrastructures are generally expensive to purchase and maintain. The administrative burden of managing a centralized key distribution center or a PKI is high. In a PKI, the issuing, revoking, and rolling over digital certificates, while also checking their validity, are ongoing tasks which illustrate the high administrative burden of managing A PKI.

A feature of using pre-installed client software is an additional disadvantage of the various methods and systems of encrypting objects known to those skilled in the art. Such pre-installed client software, such as is found with Kerberos and PKI-based Lotus Notes® by IBM Corporation of Armonk, New York, generally results in only being able to access encryption capabilities using computers on which the client software was pre-installed. Relying on pre-installed client software often limits both mobility and flexibility in the use of encryption. In addition, there is the burden of deploying new client software on users' computers as new releases of the software become available. The process of explicitly installing client software is time consuming and may not even be possible in environments such as cyber cafes, kiosks, and hotel business centers.

A feature of end users having key management responsibilities is often a disadvantage of the various methods and systems of encrypting shared objects known to those skilled in the art. For example, in many PKI-based encryption systems, the end user often has responsibility for the generation and/or protection of private keys. Placing responsibility for the generation or protection, or both, of private keys on the end user introduces opportunities for user error that could compromise the security of the private key and, consequently, the security of the system. An additional disadvantage is the requirement for the end user, in some cases, to securely move encryption keys to another computer in order to utilize encryption operations on that other computer.

A feature of using customized or proprietary client software is lack of interoperability across organizational boundaries. This is due, in part, to the need for common software and encryption keys to both encrypt and decrypt objects. Another reason is the need in many organizations to perform other security tasks, such as firewall configuration and user registration, before the sharing of encrypted objects with other organizations is possible.

A feature of existing encryption systems, such as those with centralized key distribution, and those based on PKI is lack of interoperability across organizational boundaries. This is due, in part, to the need, in many cases, for all organizations to use explicitly installed software that performs encryption operations in the same way. Another reason is the need in many organizations to perform other security tasks, such as firewall configuration and user registration, before the sharing of encrypted objects with other organizations is possible.

A feature of some existing encryption systems, viz. Kerberos and Secure Sockets Layer (SSL) is that they only provide encryption protection while an object is transmitted from one computer to another. Once an object arrives at its destination, it is decrypted and remains decrypted while stored on the destination computer. To encrypt the object while it is stored, it is necessary to utilize a separate encryption system, and the object will have to be decrypted before it is transmitted over a SSL or Kerberos-encrypted connection. This increases administration expense and complexity because two different encryption systems are used, as well as increases the number of encryption and decryption operations, which could degrade performance.

Thus, there is a need for a method and system of encrypting objects that does not have limitations found in systems, such as those with manual distribution of keys, centralized key distribution centers, or PKI. There is also a need for a method and system of encrypting objects that imposes limited or no key management responsibilities on end users or administrators, that works easily across organizational boundaries, and does not require the explicit installation of client software.

The security of any encryption-based system depends upon, among other things, the security of encryption keys. The security of these keys is dependent, among other things, upon the protections offered by client operating systems. Operating systems are software used to manage and control computers. Examples include, but are not limited to, the Windows™ family of operating systems; UNIX operating systems, such as Solaris™, HP-UX™, and AIX™; operating systems for Personal Digital Assistants (PDA), such as Palm OS™; as well as operating systems for pagers and cellular telephones. A client operating system is an operating system with which a user directly interacts, for example through use of a keyboard or mouse. Many client operating systems do not provide adequate long term protection for these keys. Consequently, there is a need for a technique including a method and system for object encryption that minimizes reliance on client operating systems for protection of encryption keys. There is a need for a method and system for object encryption with a feature that encryption keys do not need to reside on a client system for a period longer than required for the actual encryption or decryption operations.

### SUMMARY OF THE INVENTION

The present invention provides a method of encrypting an object, comprising the steps of a first active agent initiates the first key management component generating a first key management component public key/first key management component private key pair; loading an object encryption component; loading an object decryption component; creating a correlation table; a second active agent transmitting an encrypt object request to the first key management component; the first key management component transmitting an object encryption component to the second active agent computing platform over a secure channel; the first key management component transmitting the first key management component public key to the active agent computing platform over a secure channel; the object encryption component generating a symmetric key; the object encryption component encrypting a clear text object with the symmetric key; the object encryption component encrypting the symmetric key with the first key management component public key; the object encryption component creating a association between the encrypted symmetric key and the cipher text object; the object encryption component transmitting the encrypted symmetric key to the first key management component or to a second key management component having the first key management component private key; the object encryption component transmitting the association to the key management component having received the encrypted symmetric key; and, the key management component having received the association enters the association into the correlation table.

The present invention also provides a method of decrypting an object, comprising the steps of an active agent transmitting a decrypt object request to the key management component; the key management component retrieving a cipher text object symmetric key from a correlation table; the key management component decrypting cipher text object symmetric key with the key management component private key; the key management component transmitting the object decryption component to the active agent computing platform over a secure channel; the key management component transmitting the cipher text object symmetric key to the active agent computing platform over a secure channel; and the object decryption component decrypting the cipher text object with the cipher text object symmetric key.

### BRIEF DESCRIPTION OF THE DRAWINGS

FIG. 1 is a diagram illustrating the system for object encryption using transparent key management a computing platform of the present invention.

FIGS. 2(a)-(e) are diagrams illustrating a key management component, an object encryption component, and an object decryption component of the present invention operating on the same computing platform or different computing platforms.

FIG. 2(a) illustrates an embodiment of the invention where a key management component on a first computing platform, an object encryption component on a second computing platform, and an object decryption component on a third computing platform.

FIG. 2(b) illustrates an embodiment of the invention where a key management component and an object encryption component on a first computing platform, and an object decryption component on a second computing platform.

FIG. 2(c) illustrates an embodiment of the invention where an object encryption component on a first computing platform, and a key management component and an object decryption component on a second computing platform.

FIG. 2(d) illustrates an embodiment of the invention where a key management component on a first computing platform, and an object encryption component and an object decryption component on a second computing platform.

FIG. 2(e) illustrates an embodiment of the invention where a key management component, an object encryption component, and an object decryption component on a first computing platform.

FIG. 3 is a diagram illustrating an embodiment of the invention where multiple instances of a key management component 200, object encryption component 300, and object decryption component 400 operate.

FIG. 4 is a diagram illustrating functions of the key management component 200 on different computing platforms.

FIG. 5 is a block diagram illustrating the initialization of a key management component.

FIG. 6 illustrates a correlation table in which an entry is made to support the retrieval of an encrypted symmetric key, a cipher text object, other data, or any combination of the foregoing.

FIG. 7 is a diagram illustrating the overall system for encrypting a clear text object.

FIG. 8 is a block diagram illustrating the encryption of a clear text object.

FIG. 9 is a diagram illustrating the overall system for decrypting a cipher text object.

FIG. 10 is a block diagram illustrating the decryption of a cipher text object.

### DETAILED DESCRIPTION OF THE INVENTION

### DEFINITIONS

The term “computing platform” refers to any electronic device that contains memory (also referred to as storage or storage medium) has the capacity to execute programs, and communicate with other computing platforms. The term “storage” refers to both non-volatile storage, and volatile storage. Examples of non-volatile storage include, but are not limited to, hard disk magnetic storage unit, optical storage unit, CD-ROM or flash memory. Volatile storage include primary memory also known and Random Access Memory (RAM). Examples of computing platforms include, but are not limited to, laptop computers, desktop computers, personal computers (PCs), mini-computers, mainframe computers, personal digital assistants (PDA), pagers, MP3 players, cellular telephones, automobiles, aircraft, dishwashers, robots, digital cameras, set-top boxes, medical diagnostic and treatment equipment, and automated teller machines (ATMs). Many computing platforms contain both non-volatile and volatile storage.

An “object” refers to anything that can be represented in binary form, i.e., this is consisting of “0's” and “1's”. An object may be, but is not limited to, a document, without formatting or with formatting e.g., HTML, PDF, or database; picture; scanned image; photograph; video; film clips (dailies); music; telemetry; audio data; computer program; the data a computer program operates on; structured data, e.g., a database.

The term “cipher text” is used to refer to an object that has been encrypted.

The term “clear text” or “plain text” is used to refer to an object that has not been encrypted or has been decrypted.

The term “transmission” refers to sending or receiving, or both sending and receiving, any object between computing platforms or within a computing platform. The term “transmission channel” refers to Internet connections, cellular, Personal Communications Systems (PCS), microwave, satellite networks, infrared networks, or other wireless networks. Internet connections include use of a public switched phone network, e.g., networks provided by a local or regional telephone company or by dedicated data lines. The term “transmission channel” also refers to the process of writing to a medium, such as a floppy disk or CD, and physically carrying it to another computing platform The term “transmission channel” further refers to the method used to communicate between processes, including, but not limited to, inter-process communication (IPC), shared memory, global variables, and process invocation. Transmission channels may use protocols, including, but limited to HyperText Transfer Protocol (HTTP), Internet Inter-Orb Protocol (IIOP), File Transfer Protocol (FTP), Secure Sockets Layer (SSL), Telnet, or Wireless Fidelity (Wi-Fi). It will be readily understood by one of skill in the art that the present invention contemplates the use of transmission channels in addition to those listed above.

The term “secure channel” refers to a transmission channel having authenticated end points wherein the object transmitted through this transmission channel cannot be modified without detection, thus, providing integrity protection. In some situations, the object transmitted through this transmission cannot be viewed, thus providing confidentiality protection. he transmission of clear text private and symmetric keys requires the use of a secure channel with confidentiality. While confidentiality protection is always acceptable for a secure channel, is it not required except in the case of transmission of the types of encryption keys listed above. Physical and procedural protection measures can be used to create a secure channel, including physical protection of a transmission channel, e.g., concrete shielding or controlling access to computing platforms, or both. The transmittal of a digitally signed object encryption component or object decryption component over an unencrypted transmission channel can constitute a secure channel without confidentiality protection. This is because through the verification of the object encryption component's or object decryption component's digital signature, the recipient can authenticate the originator of the component as well confirm that the component's contents have not been changed. By way of example, this authentication of the component sender and validation of the component's integrity is accomplished in a Java™ environment through the use of signed JAR (Java Archive) files. It will be readily understood by one of skill in the art that authentication of the receiving end of the secure channel may be performed using other appropriate authentication methods.

A “transmitting client system” refers to a client system that transmits a cipher text object.

A “receiving client system” refers to a client system that receives a cipher text object.

A Secure Sockets Layer (SSL) connection with both server and client-side authentication constitutes a secure channel with all protection properties. Authentication may be performed by a number of different means, including passwords and digital signatures. The choice of the authentication method used is based on a variety of factors, including, but not limited to, ease of use, sensitivity of the object, cost, and hardware support. It will be readily understood by one of skill in the art that authentication may also be performed using other appropriate authentication methods.

The practice of using encryption keys, or encryption protocols to ensure the authenticity of senders and receivers, as well as the integrity of messages is well known in the art. (See Bruce Schneier, Applied Cryptography, Protocols, Algorithms, and Source Code in C. (2d Ed. John Wiley & Sons, Inc., 1995).

An “active agent” initiates or invokes the system to perform the operations of this invention. Active agents include human beings, such as administrators and interactive end users. Active agents also include computer programs. Examples of operations include initialization of the key management component, the encryption of an object, and the decryption of an object.

The present invention provides a method and system for encrypting objects using transparent key management. For the purposes of this invention, transparent key management refers to a process in which an active agent has no direct responsibility for creating, protecting, using or deleting an encryption key. A key management component, object encryption component, and object decryption component are perform all encryption operations and key management operations. Encryption operations include object encryption and object decryption.

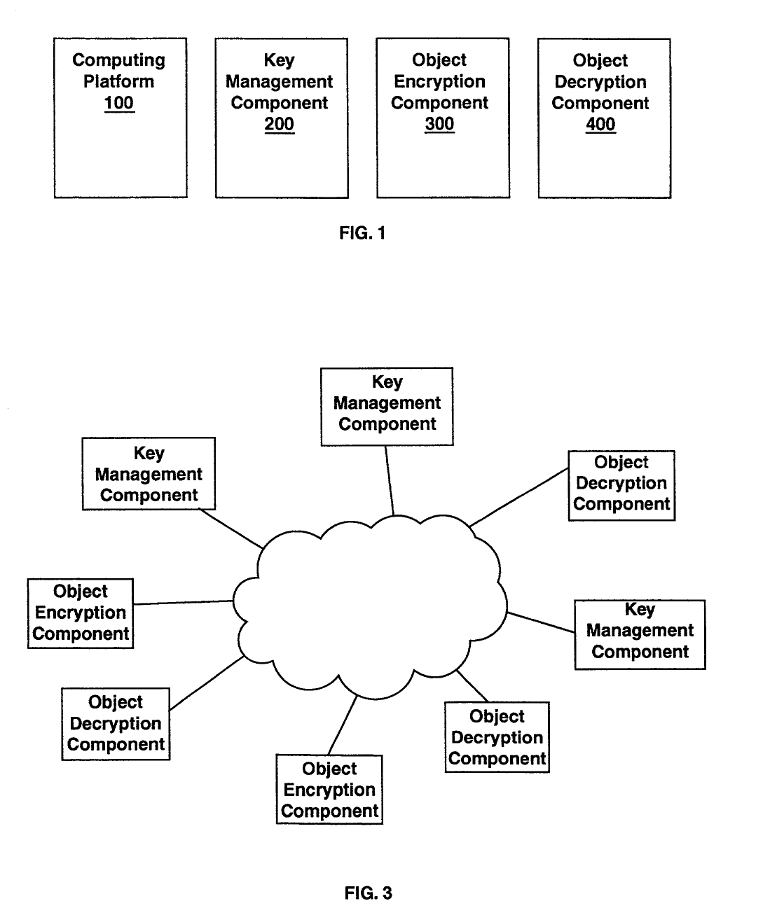

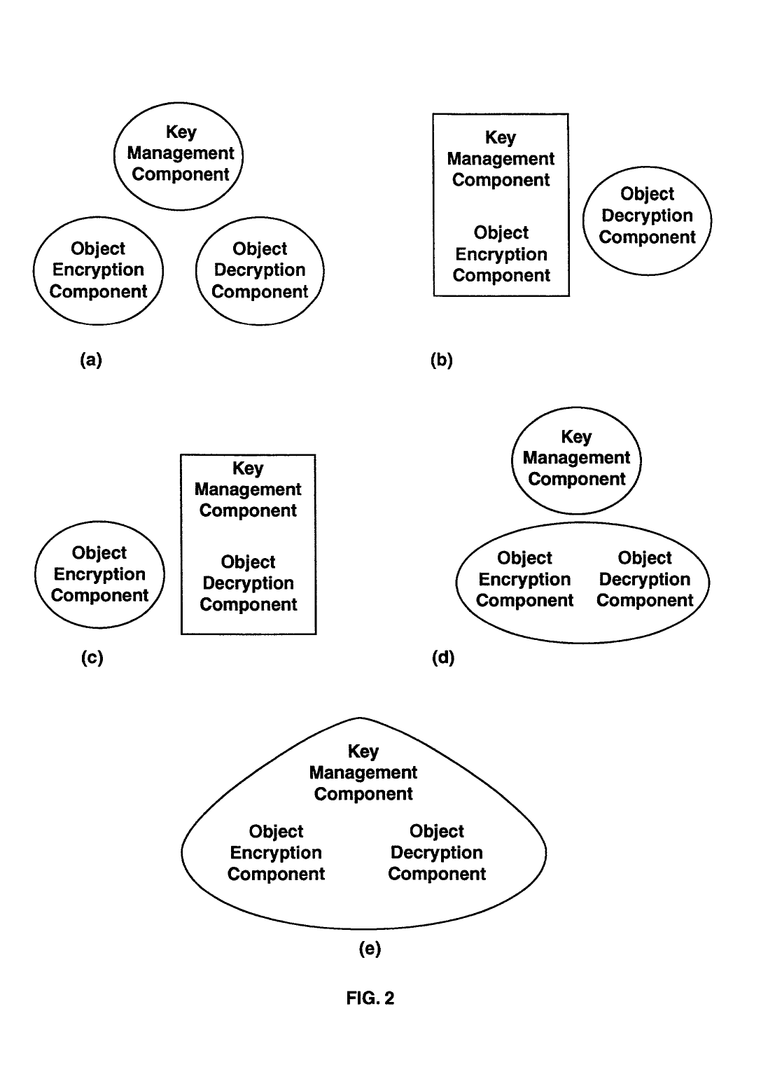

The method and system of the present invention will now be discussed with reference to FIGS. 1-10. FIG. 1 illustrates the system for object encryption using transparent key management. The system includes a computing platform 100, a key management component 200, an object encryption component 300, and an object decryption component 400. An object encryption component 300 is also referred to as an encryption program, and an object decryption program is also referred to an a decryption program. FIGS. 2(a)-(e) are diagrams illustrating a key management component, an object encryption component, and an object decryption component of the present invention operating on the same computing platform or different computing platforms.

FIG. 2(a) illustrates an embodiment of the present invention where the computing platform, a key management component 200, an object encryption component 300, and an object decryption component 400 each operate on a different computing platform. A key management component 200 operates on a first computing platform, an object encryption component 300 operates on a second computing platform, and an object decryption component 400 operates on a third computing platform. A key management component 200 in conjunction with its computing platform is referred to as an encryption server system; an object encryption component 300 and its computing platform is referred to as a client system; and, an object decryption component 400 and its computing platforms is also referred to as a client system. An encryption program may also include an object encryption component 300 and an object decryption component 400.

FIG. 2(b) illustrates an embodiment of the invention where a key management component 200 and an object encryption component 300 operate on a first computing platform, and an object decryption component 400 operate on a second computing platform. A computing platform 100 with both a key management component 200 and an object encryption component 300 is referred to as an encryption server system, or a client system, or both an encryption server system and a client system.

FIG. 2(c) illustrates an embodiment of the invention where an object encryption component 300 operates on a first computing platform, and a key management component 200 and an object decryption component 400 operate on a second computing platform. A computing platform 100 with both a key management component 200 and an object decryption component 400 is referred to as an encryption server system, or a client system, or both an encryption server system and a client system.

FIG. 2(d) illustrates an embodiment of the invention where a key management component 200 operates on a first computing platform, and an object encryption component 300 and an object decryption component 400 operate on a second computing platform.

The embodiment of the invention illustrated in FIG. 2(d) is capable of functioning as a transmitting client system, or a receiving client system, or both a transmitting client system, and a receiving client system.

FIG. 2(e) illustrate an embodiment of the invention where a key management component, an object encryption component, and an object decryption component on a first computing platform.

FIGS. 2(b), 2(c), 2(d), and 2(e) illustrate a key management component 200, object encryption component 300, and object decryption component 400, operating on the same computing platform or different computing platforms any combination. It is not necessary for a key management component 200, an object encryption component 300, or an object decryption component 400 to be present on a computing platform until its time to operate. It is not necessary for a key management component 200, an object encryption component 300, or an object decryption component 400 to remain on a computing platform after its operation is complete.

FIG. 3 illustrates an embodiment of the invention where multiple instances of a key management component 200, an object encryption component 300, and an object decryption component 400 operate. The cloud in the middle of FIG. 3 illustrates a transmission channel between each instance of a key management component 200, an object encryption component 300, and an object decryption component 400.

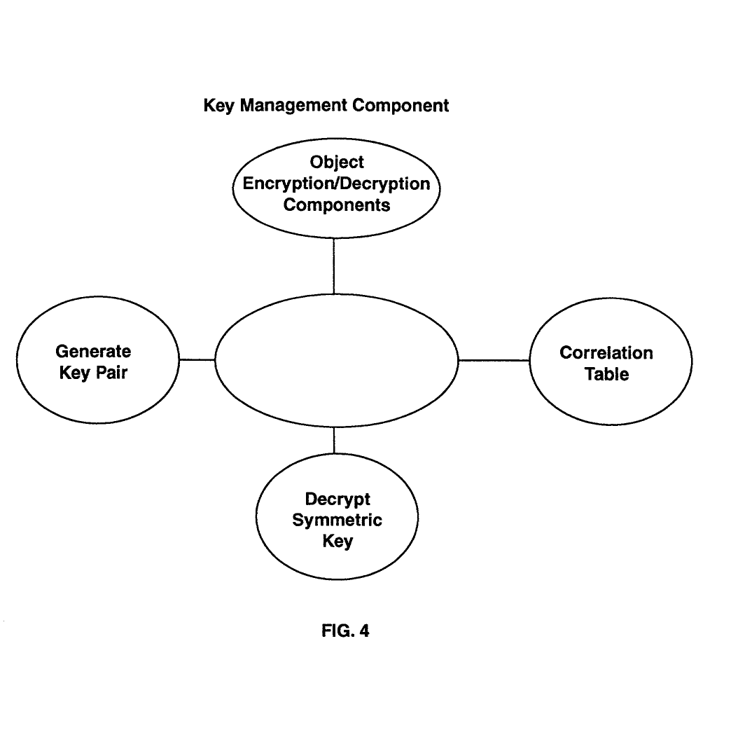

FIG. 4 illustrates that the functions of a key management component 200. The functions of a key management component 200 may reside on different computing platforms, connected by secure channels. There is no limitation on the number of computing platforms or on the combination of key management component 200 functions on a single computing platform. Key management component 200 functions include key creation, key protection, key distribution, and key deletion.

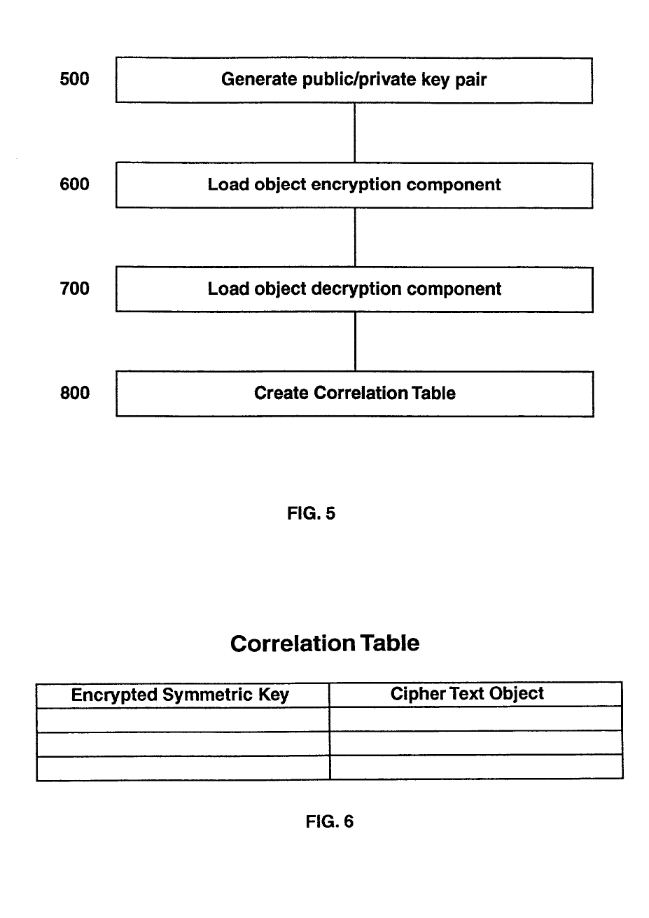

FIG. 5 is a block diagram illustrating the initialization of a key management component 200. An active agent initiates key management component 200 operations. At step 500, a public/private key pair is generated. The public/private key pair may be generated using the RSA encryption algorithm, ECC encryption algorithm, or by another public key encryption algorithm. A key management component 200 may have one or more public/private key pairs. At step 600, an object encryption component 300 is made accessible to a key management component 200. Making an object encryption component 300 accessible to a key management component 200 may be accomplished by loading an object encryption component 300 onto the same computing platform that a key management component 200 resides on. The object encryption component 300 may or may not be located on the same computing platform as the key management component 200. If the object encryption component 300 is not be located on the same computing platform as the key management component 200, the object encryption component 300 is made available to the key management component over a secure channel. At step 700, the same process takes place for an object decryption component 400, mutatis mutandis. The object decryption component 400 may or may not be located on the same computing platform as the key management component 200. If the object decryption component 400 is not be located on the same computing platform as the key management component 200, the object decryption component 400 is made available to the key management component over a secure channel. At step 800, a correlation table is created.

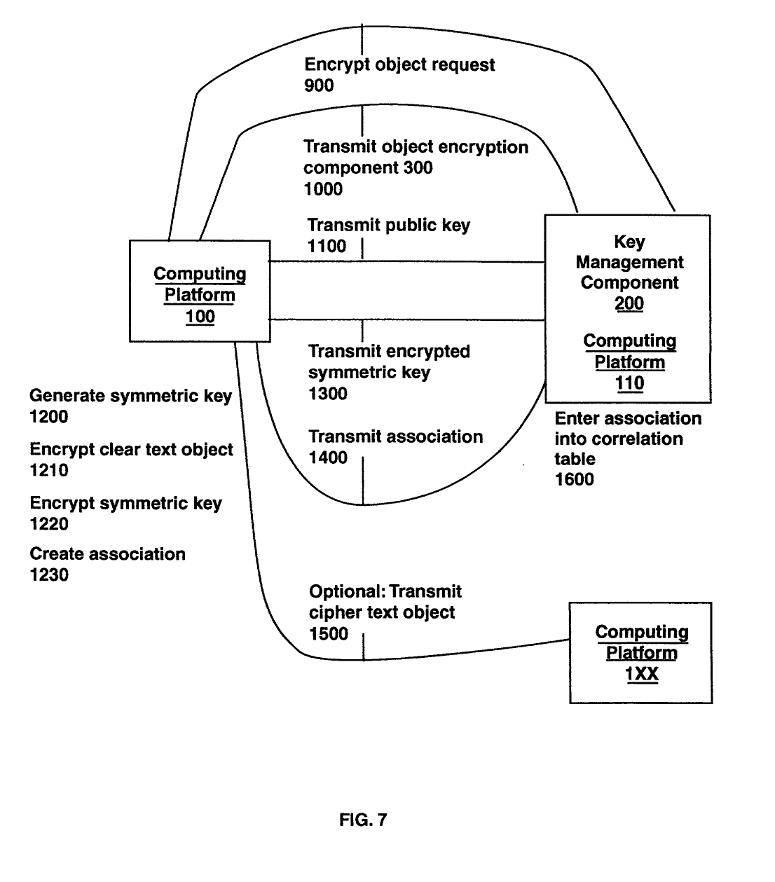

FIG. 6 illustrates a correlation table in which an entry is made to support the retrieval of an encrypted symmetric key, a cipher text object, other data, or any combination of the foregoing. For the purposes of the present invention, an entry is a tuple. Each tuple in a correlation table corresponds to one object. The correlation table shown in FIG. 6 is comprised of at least one tuple having at least two fields. Any of the at least two fields may contain a null value. A first and second field correspond to a first and second item, respectively. Thus, a correlation table maintains a relationship between two fields each having a corresponding item. A first field corresponds to an encrypted symmetric key used to encrypt a cipher text object. A second field corresponds to a cipher text object. Making a first and second entry in the same tuple of a correlation table stores the relationship created between an encrypted symmetric key and a cipher text object by the performance of step 1230 in FIG. 7.

The item entered in a field may be either the item itself, a name for the item or a pointer to the item. A pointer is a location reference to another item, which may be on the same or different computing platform. For example, an item entered in the second field may be a pointer referencing the location of an encrypted object. It is sometimes advantageous to use a pointer instead of the item itself, which is understood by one of ordinary skill in the art.

Steps 500, 600, 700, and 800, illustrated in FIG. 5, may take place during the initial set up or initialization of the system or in response to an encrypt object request at step 900 (see FIG. 6).

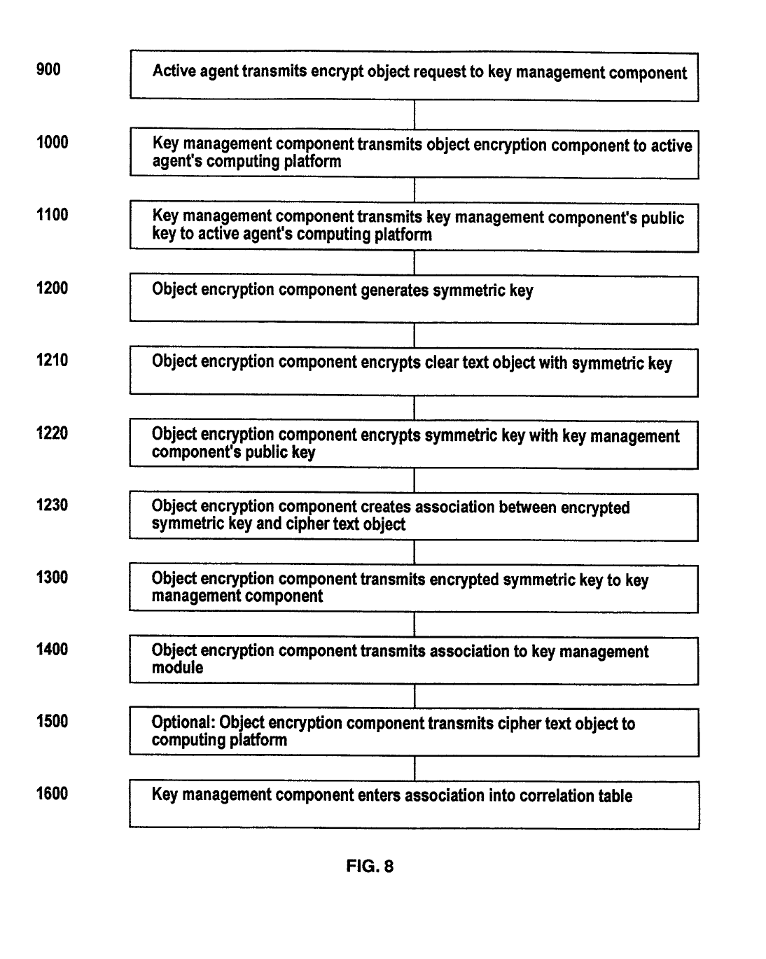

FIG. 7 is a diagram illustrating the overall system for encrypting an object using transparent key management, and FIG. 8 is a block diagram illustrating the encryption of an object using transparent key management. Referring to FIGS. 7 and 8, at step 900 an active agent makes an encrypt object request from a first computing platform 100 to key management component 200 operating on a second computing platform 110. Referring to FIGS. 7 and 8, at steps 1000 and 1100, key management component 200 responds by transmitting object encryption component 300 and a key management component public key, respectively, to the first computing platform 100 over a secure channel. The transmission of object encryption component 300 to the first computing platform 100 includes whatever steps, e.g., installation, necessary for the object encryption component 300 to operate on the first computing platform 100. A key management component public key may be transmitted with object encryption component 300 to computing platform 100 over a secure channel, thus collapsing steps 1000 and 1100 into a single operation.

Referring to FIG. 8, an object encryption component 300 controls the operation at steps 1000, 1200, 1210, 1220, 1230, 1300, 1400, 1500. At step 1200, a symmetric key is generated. A symmetric key may be generated using a symmetric encryption algorithms, e.g., Rijndael, IDEA, DES, Triple DES Blowfish, RC4, RC2, SAFER, or any other symmetric encryption algorithm.

In one embodiment of the present invention, object encryption component 300 transmitted in step 1000 generates a symmetric key at step 1200 on computing platform 100 immediately before the object encryption operation of step 1210. (See FIGS. 7 & 8.) In another embodiment of the present invention, a symmetric key can be generated on another computing platform and transmitted to computing platform 100, over a secure channel with confidentiality protection. (See FIGS. 7 & 8.) In yet another embodiment of the present invention, a symmetric key can be generated earlier than immediately before step 1210. (See FIGS. 7 & 8.)

Referring to FIG. 8, object encryption component 300 encrypts a clear text object with a symmetric key, resulting in a cipher text object at step 1210. At step 1220, object encryption component 300 encrypts a symmetric key with a key management component public key. The object encryption component 300 creates an association between an encrypted symmetric key and a cipher text object at step 1230; transmits an encrypted symmetric key to key management component 200 at step 1300; and, transmits an association between an encrypted symmetric key and a cipher text object to key management component 200 at step 1400.

Referring to FIG. 7, step 1500, object encryption component 300 can transmit a cipher text object to another computing platform, i.e., computing platform 1XX, or the cipher text object may remain on the computing platform where it was encrypted. Computing platform 1XX may be computing platform 110. Computing platform 1XX may also be a computing platform from which an active agent will make an object decryption request. Computing platform 1XX may be a computing platform without a key management component 200, an object encryption component 300, or an object decryption component 400. These examples of possible computing platforms 1XX impose no limitations on a key management component 200, an object encryption component 300, or an object decryption component 400 present on computing platform 1XX.

Referring to FIG. 8, step 1600, key management component 200 enters an association between an encrypted symmetric key and a cipher text object transmitted from object encryption component 300 at step 1400 into a correlation table (see FIG. 6) to establish and store an association or relationship.

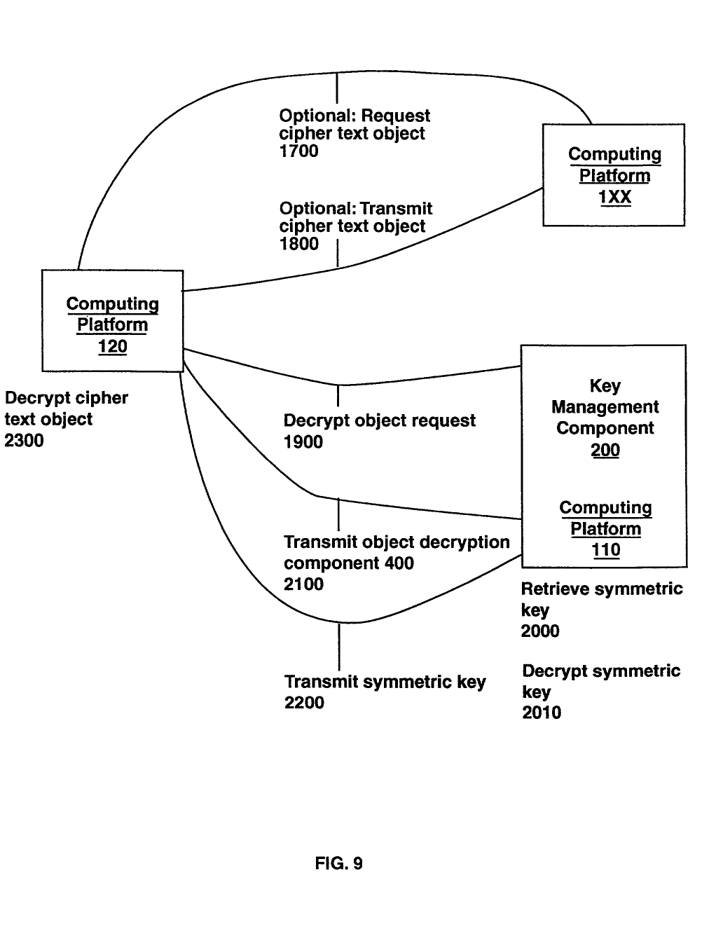

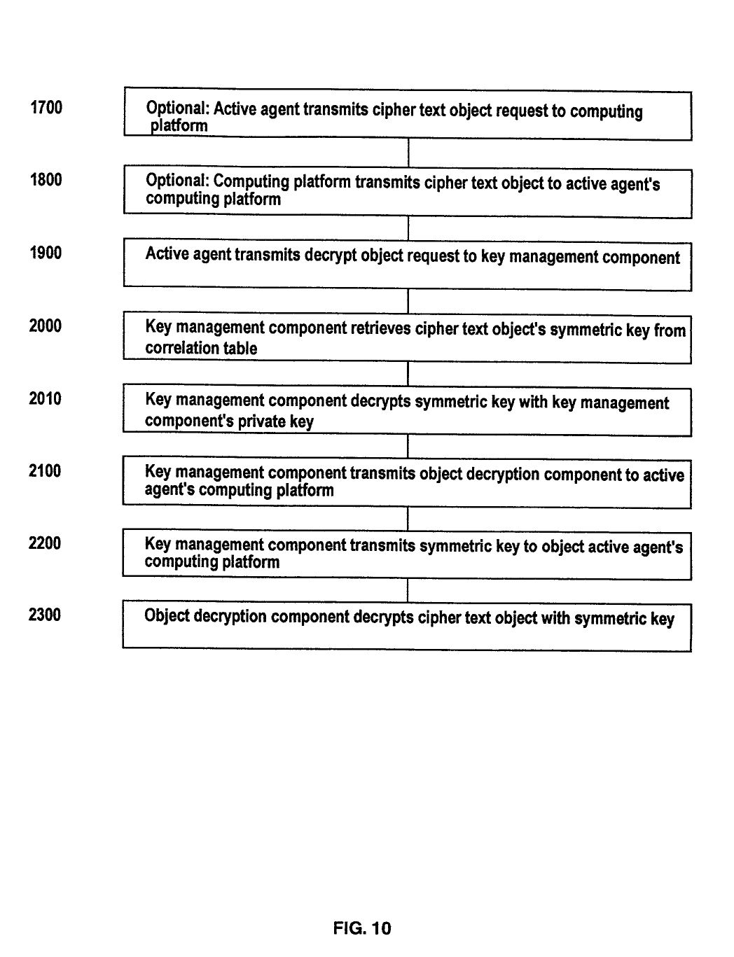

FIG. 9 illustrates the overall system for decrypting an object, and FIG. 10 is a block diagram illustrating the decryption of an object. Referring to FIG. 9, if a cipher text object is not present on computing platform 120, an active agent on computing platform 120 may optionally transmit a request for a cipher text object to computing platform 1XX, at step 1700. At step 1800, a cipher text object may be transmitted from computing platform 1XX to computing platform 120. In one embodiment of the present invention, computing platform 1XX is computing platform 110.

Referring to FIGS. 9 and 10, at step 1900, an active agent makes an object decryption request from computing platform 120 to key management component 200 on computing platform 110. Referring to FIG. 10, step 2000, key management component 200 retrieves a cipher text object's symmetric key through the use of a correlation table; and, decrypts a symmetric key with a key management component's private key at step 2010. At step 2100, key management component 200 transmits object decryption component 400 to computing platform 120. The transmission of object decryption component 400 to the first computing platform 120 includes whatever steps, e.g., installation, necessary for the object decryption component 400 to operate of the first computing platform 120. At step 2200, key management component 200 transmits a symmetric key to object decryption component 400 on computing platform 120 over a secure connection with confidentiality protection. At step 2300, object decryption component 400 decrypts a cipher text object with a symmetric key.

The present invention may be deployed in many environments, including but not limited to, the Internet, organizational intranets, cable entertainment networks, satellite entertainment networks, factories, and hospitals. The present invention may also be deployed in an Application Service Provider (ASP) environment. Deployment of the present invention in the ASP environment is advantageous because, all or some of the operations of a key management component 200 may be managed by a third party.

The key management component 200, object encryption component 300, and object decryption component 400 may be implemented in any programming language that can be executed on a computing platform, including, but not limited to, C, C++, Java, and Visual Basic. Where an object encryption component 300 is operating on a computer platform which includes an Internet Explorer® browser, the encryption program may be implemented as an Active X control; and, where an object decryption component 400 is operating on a computer platform which includes an Internet Explorer(® browser, the decryption program may be implemented as an Active X control. Where an object encryption component 300 is operating on a computer platform which includes an Internet Explorer® browser or a Netscape Navigator® browser, the encryption program may be implemented as a Java® applets; and, where an object decryption component 400 is operating on a computer platform which includes an Internet Explorer(g browser or a Netscape Navigator®) browser, the decryption program may be implemented as Java(® applets.

The source code for a key management component 200, an object encryption component 300, and an object decryption component 400 can be readily configured by one skilled in the art using well-known programming techniques and hardware components. Additionally, key management component 200, object encryption component 300, and object decryption component 400 functions may be accomplished by other means, including, but not limited to integrated circuits and programmable memory devices, e.g., EEPROM

### EXAMPLE I

This example describes the use of the present invention to securely share objects related to inter-corporate activities, e.g., mergers and acquisitions. Referring to FIG. 2(a), a key management component 200 resides on a computing platform managed by one of the parties to the inter-corporate activity, e.g., a law firm. Each of the parties participating in the inter-corporate activity has access to a computing platform, e.g., a laptop computer, from which they can request object encryption component 300 or object decryption component 400, as needed.

Referring to FIG. 5, encryption server system 200 is initialized by the generation of an ECC public/private key pair at step 500, the loading of an object encryption component 300 at step 600, the loading of an object decryption component 400 at step 700, and the creation of a correlation table at step 800. Next, one of the parties, e.g., an accountant, encrypts an object, e.g. an Excel™ spreadsheet, and transmits the cipher text Excel™ spreadsheet to a computing platform for subsequent distribution.

Referring to FIG. 7, an active agent on computing platform 100, also known as a client system, transmits an encrypt object request to key management component 200 on computing platform 110, also known as an encryption server system, using HTTP, at step 900. Key management component 200 responds by transmitting an object encryption component over an SSL channel to computing platform 100, at step 1000. The object encryption component sent to computing platform 100, at step 1000, is a Java(® encryption applet. (Java(® is a programming language developed by Sun Microsystems of Mountain View, Calif.) The key management component's 200 public key is included in the Java(® encryption applet transmitted from key management component 200 to computing platform 100, collapsing steps 1000 and 1100 of FIG. 7 into a single step.

Referring to FIG. 7, the Java® object encryption component applet, running in conjunction with an Internet Explorer™ browser, generates 168-bit Triple DES symmetric key (U.S. Government standard, specified in FIPS PUB 46-3), at step 1200. This symmetric key is used to encrypt a Excel™ spreadsheet, at step 1210. The symmetric key is in turn encrypted with a key management component's public key, at step 1220. At step 1300, the encrypted symmetric key is transmitted from computing platform 100 to key management component 200 via HTTP. At step 1400, an association between an encrypted symmetric key and a cipher text object is transmitted from computing platform 100 to key management component 200. At step 1500, a cipher text object is transmitted to from computing platform 100 to key management component 200 via FTP.

Next, one of the other parties, e.g., an investor, requests the cipher text object, e.g., an Excel™ spreadsheet. Referring to FIG. 9, an active agent on computing platform 120, also known as a client system, transmits a request for the cipher text object at step 1700 and transmits a decrypt object request at step 1900 to key management component 200 on computing platform 110, also known as an encryption server system, using HTTP. Key management component 200 responds by transmitting a cipher text object to computing platform 120, at step 1800 via FTP.

Referring to FIG. 9, key management component 200 retrieves and decrypts a symmetric key at steps 2000 and 2100, respectively. Key management component 200 transmits an object decryption component and clear text symmetric key over an SSL channel to computing platform 120, at steps 2100 and 2200, respectively. The object decryption component sent to computing platform 120, at step 2100, is a Java® encryption applet. The Java® object decryption component applet, running in conjunction with an Internet Explorer™ browser, decrypts the cipher text Excel™ spreadsheet at step 2300.

### EXAMPLE II

This example describes a financial institution's use of the present invention to securely distribute electronic copies of canceled checks or electronic copies of point of sale receipts, or both. The financial institution has a computing platform 110 that has a key management component 200 and an object encryption component 300. At least one financial institution customer has a computing platform from which he can request an object decryption component 400 and a cipher text electronic image of a check or point of sale receipt.

Referring to FIG. 5, key management component 200 is initialized by the generation of an RSA public/private key pair at step 500, the loading of an object encryption component 300 at step 600, the loading of an object decryption component 400 at step 700, and the creation of a correlation table at step 800.

Referring to FIG. 7, an active agent on computing platform 110 transmits an encrypt object request to key management component 200 on computing platform 110, using Inter-Process Communication (IPC), at step 900. Key management component 200 responds by transmitting an object encryption component 300 and a key management component public key via shared memory, at steps 1000 and 1100, respectively. The object encryption component 300 sent to computing platform 100, at step 1000, is a computer program written in the C++ language.

Referring to FIG. 7, the C++object encryption component program generates a 128 bit IDEA symmetric key. This symmetric key is used to encrypt a clear text electronic image of a check or point of sale receipt, at step 1210. The symmetric key is then encrypted with a key management component's public key, at step 1220. At step 1300, the encrypted symmetric key is transmitted from object encryption component 300 to key management component 200 via IPC. At step 1400, an association between an encrypted symmetric key and a cipher text object is transmitted from object encryption component 300 to key management component 200 via IPC.

Next, a financial institution customer requests an electronic image of a check or point of sale receipt. Referring to FIG. 9, an active agent on computing platform 120 transmits the request for an electronic image of a check or point of sale receipt at step 1700 and transmits a decrypt object request at step 1900 to key management component 200 on computing platform 110, using HTTP. Key management component 200 responds by transmitting a cipher text object to computing platform 120, at step 1800 via FTP. Key management component 200 retrieves and decrypts a symmetric key at steps 2000 and 2100, respectively. Key management component 200 transmits an object decryption component and clear text symmetric key over an SSL channel to computing platform 120, at steps 2100 and 2200, respectively. The object decryption component sent to computing platform 120, at step 2100, is a Java® applet. The Java® applet, running in conjunction with a Navigator™ browser, decrypts the cipher text check image at step 2300.

### EXAMPLE III

This example describes a movie studio's use of the present invention to securely distribute films to movie theaters. The movie studio has a computing platform 110 that has a key management component 200 and an object encryption component 300. At least one movie theater has a computing platform from which it can request an object decryption component 400 and a cipher text film.

Referring to FIG. 5, key management component 200 is initialized by the generation of an RSA public/private key pair at step 500, the loading of an object encryption component 300 at step 600, the loading of an object decryption component 400 at step 700, and the creation of a correlation table at step 800. Next, a film on computing platform 110 is encrypted for subsequent distribution to at least one movie theater.

Referring to FIG. 7, an active agent on computing platform 110 transmits an encrypt object request to key management component 200 on computing platform 110, using Inter-Process Communication (IPC), at step 900. Key management component 200 responds by transmitting an object encryption component 300 and a key management component public key via shared memory, at steps 1000 and 1100, respectively. The object encryption component sent to computing platform 100, at step 1000, is a computer program written in the C++language.

Referring to FIG. 7, the C++object encryption component program generates a 128-bit Rijndael symmetric key. This symmetric key is used to encrypt a digital representation of a film, at step 1210. The symmetric key is in turn encrypted with a key management component's public key, at step 1220. At step 1300, the encrypted symmetric key is transmitted from object encryption component 300 to key management component 200 via IPC. At step 1400, an association between an encrypted symmetric key and a cipher text object is transmitted from object encryption component 300 to key management component 200 via IPC.

Next, at least one movie theater requests a film. Referring to FIG. 9, an active agent on the movie theater computing platform 120 transmits a request for a film at step 1700 and transmits a decrypt object request at step 1900 to key management component 200 on computing platform 110, using HTTP. Key management component 200 responds by transmitting a cipher text object to computing platform 120, at step 1800 via FTP. Key management component 200 retrieves and decrypts a symmetric key at steps 2000 and 2100, respectively. Key management component 200 transmits an object decryption component and clear text symmetric key over an SSL channel to computing platform 120, at steps 2100 and 2200, respectively. The object decryption component sent to computing platform 120, at step 2100, is a Java® applet. The Java® applet, running in conjunction with a Navigator™ browser, decrypts the film at step 2300.

### EXAMPLE IV

This example describes the use of the present invention to ensure secure collaboration during production of a film by sharing objects using transparent key management. Useful shared objects in this environment include, but are not limited to, film clips (dailies), music, and documents, such as, contracts, production costs, comments, and notes. The movie studio has a computing platform 110 that includes key management component 200. Each party participating in the film production has access to a computing platform, e.g., laptop computer or desktop computer, from which they can request object encryption component 300 or object decryption component 400, as needed.

Referring to FIG. 5, key management component 200 is initialized by the generation of an ECC public/private key pair at step 500, the loading of an object encryption component 300 at step 600, the loading of an object decryption component 400 at step 700, and the creation of a correlation table at step 800.

Next, dailies are encrypted and the cipher text dailies are transmitted to a computing platform for subsequent distribution. The encryption of the dailies and transmission of the cipher text dailies may be under the control of a member of the film production team, e.g., the director, cinematographer, or editor. Referring to FIG. 7, the a member of the production team transmits an encrypt object request from computing platform 100 to key management component 200 on computing platform 110, using HTTP, at step 900. Key management component 200 responds by transmitting an object encryption component over an SSL channel to computing platform 100, at step 1000. The object encryption component sent to computing platform 100, at step 1000, is a Java® applet. The key management component's public key is included in the Java® applet transmitted from key management component 200 to computing platform 100, collapsing steps 1000 and 1100 into a single step.

Referring to FIG. 7, the Java® applet, running in conjunction with an Navigator® browser, generates a 128-bit RC4 symmetric key, at step 1200. This symmetric key is used to encrypt the dailies, at step 1210. The symmetric key is in turn encrypted with a key management component's public key, at step 1220. At step 1300, the encrypted symmetric key is transmitted from computing platform 100 to key management component 200 via HTTP. At step 1400, an association between an encrypted symmetric key and a cipher text object is transmitted from computing platform 100 to key management component 200. At step 1500, a cipher text object is transmitted to from computing platform 100 to key management component 200 via FTP.

Next, another member of the production team, e.g., the producer, makes a request for dailies. Referring to FIG. 9, the production team member transmits a request from computing platform 120 for the cipher text dailies at step 1700 and a decrypt object request at step 1900 to key management component 200 on computing platform 110, using HTTP. Key management component 200 responds by transmitting a cipher text object to computing platform 120, at step 1800 via FTP. Key management component 200 retrieves and decrypts a symmetric key at steps 2000 and 2100, respectively. Key management component 200 transmits an object decryption component and clear text symmetric key over an SSL channel to computing platform 120, at steps 2100 and 2200, respectively. The object decryption component sent to computing platform 120, at step 2100, is a Java® applet. Referring to FIG. 9, the Java® applet, running in conjunction with an Navigator® browser, decrypts the cipher text dailies at step 2300. Multiple members of the production team may make a request for dailies.

Although the foregoing invention has been described in detail for purposes of understanding, it will be apparent that certain modification may be practiced within the scope of the appended claims. Those of skill in the art will recognize that the above description of the foregoing invention is illustrative of the principals of the present invention. Numerous modifications, variations, and adaptations thereof described will be readily apparent to those skilled in the art without departing from the spirit and scope of the present invention.

What is claimed is:

1. A method of encrypting an object, comprising the steps of:
a first active agent initiating the first key management component generating a first key management component public key/first key management component private key pair;
loading an object encryption component;
loading an object decryption component;
creating a correlation table;
a second active agent transmitting an encrypt object request to the first key management component;
the first key management component transmitting an object encryption component to the second active agent computing platform over a secure channel;
the first key management component transmitting the first key management component public key to the active agent computing platform over a secure channel;
the object encryption component generating a symmetric key;
the object encryption component encrypting a clear text object with the symmetric key;
the object encryption component encrypting the symmetric key with the first key management component public key;
the object encryption component creating an association between the encrypted symmetric key and the cipher text object the object encryption component transmitting the encrypted symmetric key to the first key management component or to a second key management component having the first key management component private key;
the object encryption component transmitting the association to the key management component having received the encrypted symmetric key; and,
the key management component having received the association entering the association into the correlation table.

2. The method of claim 1, further comprising the step of the object encryption component transmitting the cipher text object to a computing platform.

3. The method of claim 1, wherein the first key management component public key/first key management component private key pair is generated using an encryption algorithm selected from the group consisting of ECC and RSA.

4. The method of claim 1, wherein the secure channel is an SSL channel.

5. The method of claim 1, wherein the object encryption component is installed on a browser.

6. The method of claim 5, wherein the browser is the Internet Explorer™ or the Navigator®.

7. The method of claim 5, wherein the object encryption component is implemented as a Java® applet.

8. The method of claim 5, wherein the browser is the Internet Explorer™ and the object encryption component is implemented as an Active X™ control.

9. The method of claim 1, wherein the object encryption component is comprised of a symmetric encryption algorithm selected from the group consisting of IDEA, DES, Blowfish, RC4, RC2, SAFER, and AES.

10. A method of decrypting an object, comprising the steps of:
an active agent transmitting a decrypt object request to the key management component;
the key management component retrieving a cipher text object symmetric key from a correlation table;
the key management component decrypting cipher text object symmetric key with the key management component private key;
the key management component transmitting the object decryption component to the active agent computing platform over a secure channel;
the key management component transmitting the cipher text object symmetric key to the active agent computing platform over a secure channel; and
the object decryption component decrypting the cipher text object with the cipher text object symmetric key.

11. The method of claim 10, further comprising the step of the active agent transmitting the cipher text object request to a computing platform.

12. The method of claim 10, further comprising the step of a computer platform transmitting the cipher text object to the active agent computing platform.

13. The method of claim 10, wherein the secure channel is an SSL channel.

14. The method of claim 10, wherein the object decryption component is installed on a browser.

15. The method of claim 14, wherein the browser is the Internet Explorer™ or the Navigator.

16. The method of claim 14, wherein the object decryption component is implemented as a Java® applet.

17. The method of claim 14, wherein the browser is the Internet Explorer™ and the object encryption component is implemented as an Active X™ control.

18. The method of claim 10, wherein the object decryption component is comprised of a symmetric encryption algorithm selected from the group consisting of IDEA, DES, Blowfish, RC4, RC2, SAFER, and AES.

19. A method of encrypting an object, comprising:
under control of a first encryption server system,
generating a public/private key pair for an encryption server system;
under control of a client system,
requesting an encryption program from an encryption server system;
requesting a server public key from an encryption server system;
under the control of an encryption server system,
transmitting an encryption program to a client system over a secure channel;
transmitting a server public key to a client system over a secure channel;
under control of a client system,
receiving an encryption program from an encryption server system over a secure channel;
receiving a server public key from an encryption server system over a secure channel;
installing an encryption program on a client system;
running an encryption program on a client system to generate a symmetric key;
encrypting a clear text object with a symmetric key, thereby creating a cipher text object;
creating a relationship between a cipher text object and a symmetric key;
encrypting symmetric key with an encryption server public key, thereby creating an encrypted symmetric key;
creating a relationship between a cipher text object and an encrypted symmetric key;
transmitting a cipher text object to an encryption server system;
transmitting an encrypted symmetric key to an encryption server system;
transmitting the relationship between a cipher text object and an encrypted symmetric key to an encryption server system;
under the control of an encryption server system, storing a cipher text object in a storage medium;
storing an encrypted symmetric key in a storage medium; and
storing the relationship between a cipher text object and an encrypted symmetric key in a storage medium.

20. An encryption system for transparent key management object encryption, comprising:
an encryption server system and a client system;
an encryption server system,
generating a public/private key pair for an encryption server system;
transmitting an encryption program to a client system over a secure channel;
transmitting a server public key to a client system over a secure channel;
storing an encrypted object in a storage medium;
storing an encrypted symmetric key in a storage medium;
storing the relationship created between a object and a symmetric key in a storage medium;
a client system,
requesting an encryption program from an encryption server system;
requesting a server public key from an encryption server system;
receiving an encryption program from encryption server system over a secure channel;
receiving a server public key from encryption server system over a secure channel;
installing an encryption program on a client system;
running an encryption program on a client system to generate a symmetric key;
encrypting a clear text object with a symmetric key, thereby creating a cipher text object;
creating a relationship between a cipher text object and a symmetric key;
encrypting symmetric key with an encryption server public key, thereby creating an encrypted symmetric key;
creating a relationship between a cipher text object and a encrypted symmetric key;
transmitting a cipher text object to an encryption server system;
transmitting an encrypted symmetric key to an encryption server system;
transmitting the relationship between a cipher text object and an encrypted symmetric key to an encryption server system.

21. An encryption system for transparent key management object encryption, comprising:
an encryption server system and a client system;
an encryption server system,
using the first entry in a correlation table to retrieve an encrypted symmetric key;
decrypting a symmetric key using an encryption server system private key, thereby creating a decrypted symmetric key;
inserting a symmetric key into a decryption program;
sending a decryption program to a client system over a secure channel;
sending a cipher text object to a client system;
under control of a client system,
requesting a cipher text object from a server;
under control of an encryption server system,
installing a decryption program on a client system; and,
decrypting a cipher text object using a decryption program, thereby creating a clear text object.

22. An encryption system for transparent key management object encryption, comprising:
an encryption server system and a client system;
under control of an encryption server system,
generating a symmetric key;
encrypting a clear text object with a symmetric key, thereby creating a cipher text object;
inserting a symmetric key into a decryption program;
sending a decryption program to a client system over a secure channel;
sending a cipher text object to a client system;
under control of a client system,
requesting a clear text object from a server;
installing a decryption program on a client system; and,
decrypting a cipher text object using a decryption program, thereby creating a clear text object.

23. An encryption system for transparent key management object encryption, comprising:
an encryption server system and a client system;
an encryption server system,
generating a public/private key pair for an encryption server system;
transmitting an encryption program to a client system over a secure channel;
transmitting a server public key to a client system over a secure channel;
storing a cipher text object in a storage medium;
storing an encrypted symmetric key in a storage medium;
storing the relationship created between a cipher text object and an encrypted symmetric key in a storage medium;
using the first entry in a correlation table to retrieve an encrypted symmetric key;
decrypting a symmetric key using an encryption server system private key, thereby creating a decrypted symmetric key;
inserting an encrypted symmetric key into a decryption program;
sending a decryption program to a client system over a secure channel;
sending a cipher text object to a client system;
decrypting an encrypted symmetric key using an encryption server system private key, thereby creating a decrypted symmetric key;
sending a cipher text object to a client system;
generating a symmetric key;
encrypting a clear text object with a symmetric key, thereby creating a cipher text object;
a client system,
requesting an encryption program from an encryption server system;
requesting a server public key from an encryption server system;
receiving an encryption program from encryption server system over a secure connection;
receiving a server public key from an encryption server system over a secure channel;
installing an encryption program on a client system;
running an encryption program on a client system to generate a symmetric key;
encrypting a clear text object with a symmetric key, thereby creating a cipher text object;
creating a relationship between a cipher text object and a symmetric key;
encrypting symmetric key with an encryption server public key, thereby creating an encrypted symmetric key;
creating a relationship between a cipher text object and an encrypted symmetric key;
transmitting an object encrypted with a symmetric key from a client system to an encryption server system;
transmitting a symmetric key encrypted with a server public key from a client system to a encryption server system;
transmitting the relationship between a cipher text object and an encrypted symmetric key to an encryption server system;
requesting a cipher text object from a server;
installing a decryption program on a client system; and,
decrypting a cipher text object using a decryption program, thereby creating a clear text object; and,
requesting a clear text object from a server.
